(19) United States
(12) Patent Application Publication
(10) Pub. No.: US 2014/0322460 A1
(43) Pub. Date: Oct. 30, 2014

(54) RAISED PANELS OF POPLAR BARK

(71) Applicants: Robert C. Anderson, Hickory, NC (US); Michael Anderson, Asheville, NC (US); Tracy F. Hart, Honaker, VA (US)

(72) Inventors: Robert C. Anderson, Hickory, NC (US); Michael Anderson, Asheville, NC (US); Tracy F. Hart, Honaker, VA (US)

(21) Appl. No.: 14/234,264

(22) PCT Filed: Jul. 25, 2012
(86) PCT No.: PCT/US12/48061

§ 371 Date: Jun. 23, 2014

Related U.S. Application Data
(60) Provisional application No. 61/512,998, filed on Jul. 29, 2011.
(60) Provisional application No. 61/512,499, filed on Jul. 28, 2011.

(51) Int. Cl. E04F 15/02; B32B 38/00; E04F 13/08; E04F 15/10

(52) U.S. Cl. CPC E04F 15/02166; E04F 15/107; B32B 38/0004; E04F 13/0866; B32B 38/0012; E04F 15/02038; B32B 2038/0016
USPC 428/22; 156/250; 156/154; 52/588.1

(57) ABSTRACT

A panel for use in an architectural installation includes a poplar bark slab having a top face, bottom face and two opposed sides. The bottom face is laminated to a backing to make a composite, the top face has lands and crevasses. A filler on the top face fills the crevasses and a coating covers the filler and presenting a smooth, flat outer surface. The resulting composite panel with filler and coating is machined to obtain a shape selected from the group consisting of flooring, wall panel, ceiling panel, chair rail, door or window frame or crown molding.

The present application claims the benefit of the filing dates of these three United States provisional applications, the disclosures of which are hereby incorporated herein by reference:

| Serial Number | Filing Date |
|---|---|
| 61/512,499 | Jul. 28, 2011 |
| 61/512,998 | Jul. 29, 2011 |
| 65/645,911 | May 14, 2012 |

### BACKGROUND OF THE INVENTION

It is known that the poplar tree, particularly the tulip poplar, is durable and workable, at least to a limited extent. It is known to harvest the bark from poplar trees, sometimes as bark harvested from standing trees, sometimes as cut timber, to be made into shingles for outdoor siding. In Western North Carolina, in late summer, the bark can be harvested from the logs rather readily, peeling off in relatively intact slabs. One company in particular, Barkclad Natural Products, peels the bark from the logs and then carries the bark to a pallet where it is placed on slats and stacked flat. The bark is placed in a kiln and dried with a minimum temperature of 150 degrees Fahrenheit. The process destroys eggs, larva, and insects without the use of chemicals. When the moisture content is lowered to between 8 and 12 percent, the bark is removed from the pallets, placed on saws and cut to standard lengths. It is then loaded and banded on shipping pallets to users. The Barkclad Company is located at 217 Bethel Drive, Canton, N.C. 28717. The Barkclad Company teaches installation methods that lap the bark shingle on a house exterior, in a typical shingle application.

Other uses of such bark are known such a chest drawer front, apparently with the bark surface mounted on a drawer box, as seen as www.custommade.com/poplar-bark-chest/by/maylandcourtfinefurniture. That chest is also silver leafed, providing a contrast of the silver leaf surface with darkened grooves that naturally occur with the bark. Similar pieces are seen at www.custommade.com/poplar-bark-cube-nightstand/by/MaylandCourtFineFurniture and www.custommade.com/chest-with-poplar-bark-drawer-fronts/by/MaylandCourtFineFurniture

However, applicants are not aware of anyone using poplar bark for other purposes, and have surprisingly found additional uses for poplar bark creating unique, new decorative look with appropriate processing.

### SUMMARY OF THE INVENTION

The present invention fulfills one or more of these needs in the art by providing a raised panel that includes a poplar bark slab laminated to a backing to make a panel composite. One advantageous use of the panel is to make into a flooring panel.

The flooring panel may include a poplar bark slab having a top face, bottom face and two opposed sides. The bottom face is adhered to a backing to make a flooring composite. The top face has lands and crevasses, a filler on the top face of the slab fills the crevasses, and a coating covers the filler and presents a smooth, flat outer surface. One of the opposed sides preferably has a tongue protruding from it and the other preferably has a groove shaped, sized and located to receive and retain a tongue protruding from an adjacent flooring panel.

The backing may be selected from the group consisting of medium density fiberboard (MDF) and plywood. The backing may have a thickness of ⅛ to ¼ inch. Other thicknesses may also be used within the scope of the invention. The filler may be a resin filler, such as a blend of acrylic and polyester. The filler may contain pigment to impart color to the filler.

The invention can also be considered as a method of making a panel including sanding the back side of a poplar bark slab to obtain flatness, laminating the back side of the poplar bark slab to a stabilizing backing to make a panel composite, planing the bark side of the panel composite of bark and backing to a desired thickness, cutting the composite panel to a desired size, removing dust from crevasses in the composite panel, applying a resin to the bark side of the composite to fill the crevasses, and applying a top coat to the resin to obtain hardness of the bark side of the composite.

The invention may also be considered as a panel for use in an architectural installation including a poplar bark slab having a top face, bottom face and two opposed side edges, the bottom face being laminated to a backing to make a composite, the top face having lands and crevasses. A filler on the top face of the slab fills the crevasses, and a coating covers the filler and presents a smooth, flat outer surface. The resulting composite panel with filler and coating has been machined to obtain a shape selected from the group consisting of flooring, wall panel, ceiling panel, chair rail, door or window frame or crown molding. To make flooring, the side edges may be machined to create complementary tongues and grooves.

The invention may also be considered as a raised panel that includes a poplar bark slab laminated to a backing to make a panel composite. The panel composite has a thickness of ⅞^{th} inch, including a medial portion having lands and crevasses and a perimeter machined to a thickness of 7/16^{th} inch. Rails and stiles surround the panel composite, forming a frame around the panel composite, with the rails and stiles having grooves with the perimeter of the panel composite engaged in the grooves. The crevasses preferably run substantially continuously from one side to the other of the poplar bark slab. Preferably, the lands exhibit a wood grain. Other thicknesses may also be used within the scope of the invention.

In other embodiments, the panel composite has a thickness of ⅝^{th} inch. In other embodiments, the perimeter has a thickness of ¼ inch. In preferred embodiments the panel composite is coated with a pre-catalyzed lacquer. The backing may be selected from the group consisting of medium density fiberboard (MDF) and plywood. The backing may have a thickness of ⅛ to ¼ inch. In other embodiments, the panel composite includes two poplar bark slabs, each laminated to one side of the backing. Other thicknesses may also be used within the scope of the invention.

The invention can also be considered as a method of making a raised panel including laminating a poplar bark slab to a stabilizing backing to make a panel composite, planing the panel composite of bark and backing to a desired thickness, cutting the composite panel to a desired size, shaping the edges of the perimeter of the composite panel with a raised panel routing/shaper bit, to obtain composite panel edges that taper down to a desired, reduced profile, sanding the bark side of the panel, removing dust from crevasses in the composite panel, sealing the panel composite, spraying lacquer on the composite panel, and mounting the composite panel into surrounding stiles and rails in conventional fashion to yield a raised panel.

Sealing may include applying two coats of vinyl sealer.

Spraying pre-catalyzed lacquer may include spraying two coats of pre-catalyzed lacquer.

Laminating may include laminating the bark to a backing selected from the group consisting of medium density fiberboard (MDF) and plywood.

Laminating may include laminating two slabs of bark, one to each side of the backing to yield a double-sided panel.

### BRIEF DESCRIPTION OF THE DRAWINGS

The invention will be better understood by a reading of the Detailed Description of the Examples along with a review of the drawings, in which:

FIG. 1 is a plan view of a panel in accordance with an embodiment;

FIG. 2 is a sectional view of the embodiment of FIG. 1 taken along lines 2-2 and looking in the direction of the arrows;

FIG. 3 is an end view of the embodiment of FIG. 1;

FIG. 4 is a perspective view the embodiment of FIG. 1;

FIG. 5 is a front perspective view of a first furniture product made using panels in accordance with an embodiment;

FIG. 6 is a front perspective view of a second furniture product made using panels in accordance with an embodiment;

FIG. 7 is a front perspective view of a third furniture product made using panels in accordance with an embodiment;

FIG. 8 is a front perspective view of a fourth furniture product made using panels in accordance with an embodiment; and

FIG. 9 is a front perspective view of a door for a doorway made using panels in accordance with an embodiment.

FIG. 10 is a perspective view of a composite for a flooring board made using poplar bark in accordance with an embodiment.

FIG. 11 is a schematic perspective view of a flooring board made using poplar bark in accordance with an embodiment.

### DETAILED DESCRIPTION OF EXAMPLES OF THE INVENTION

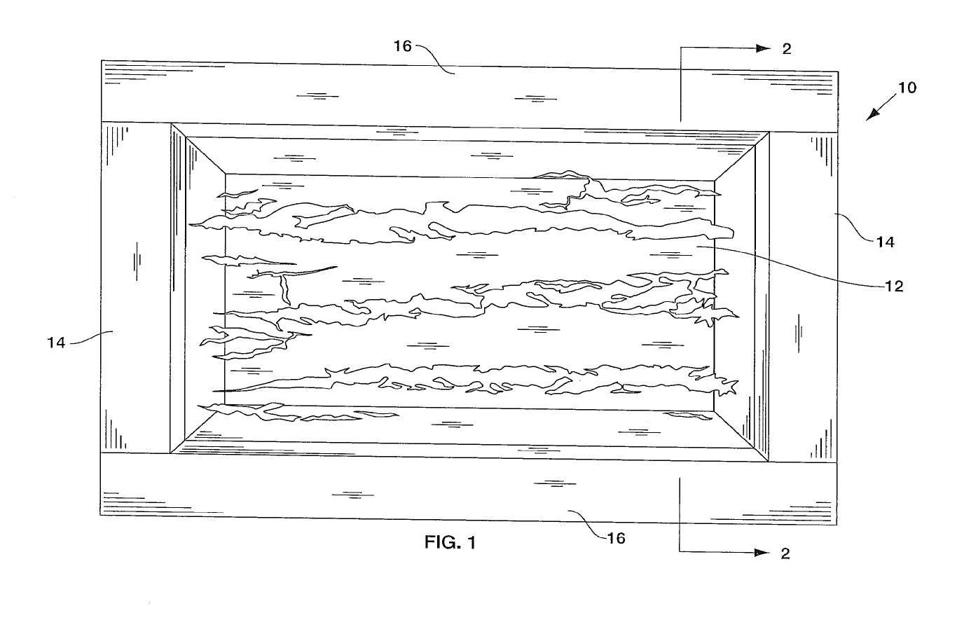

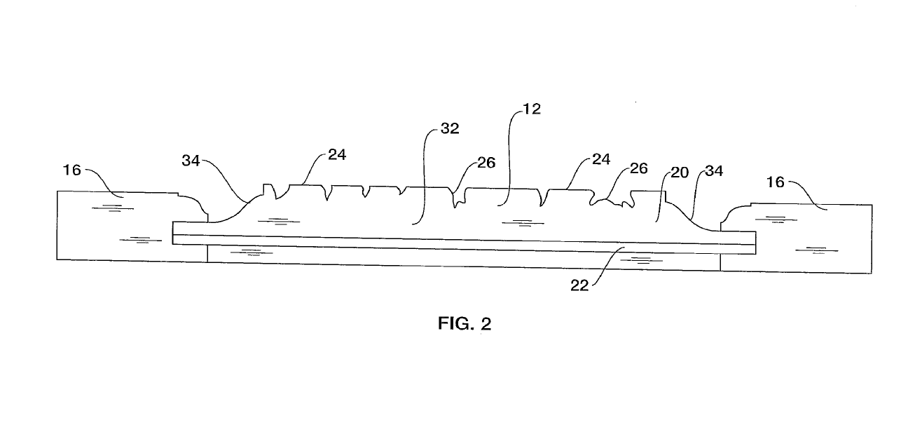

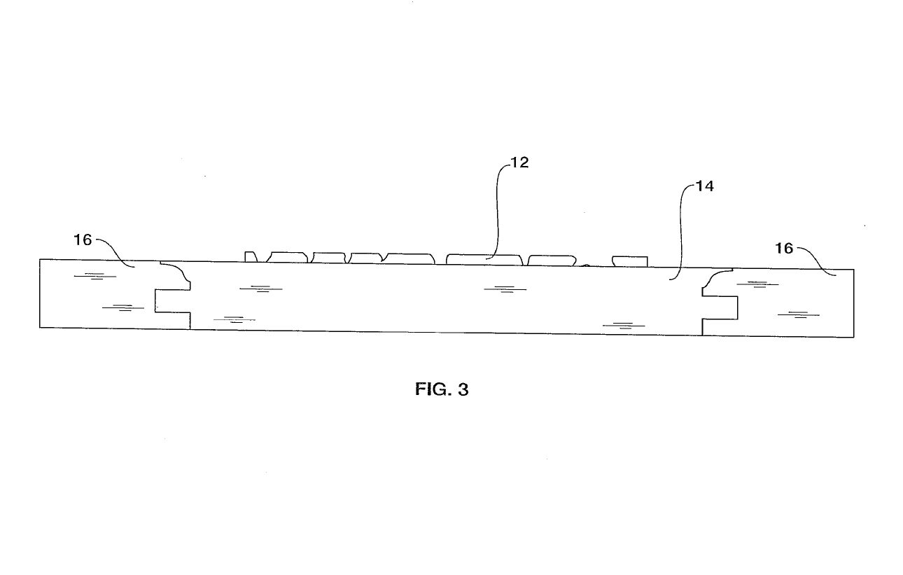

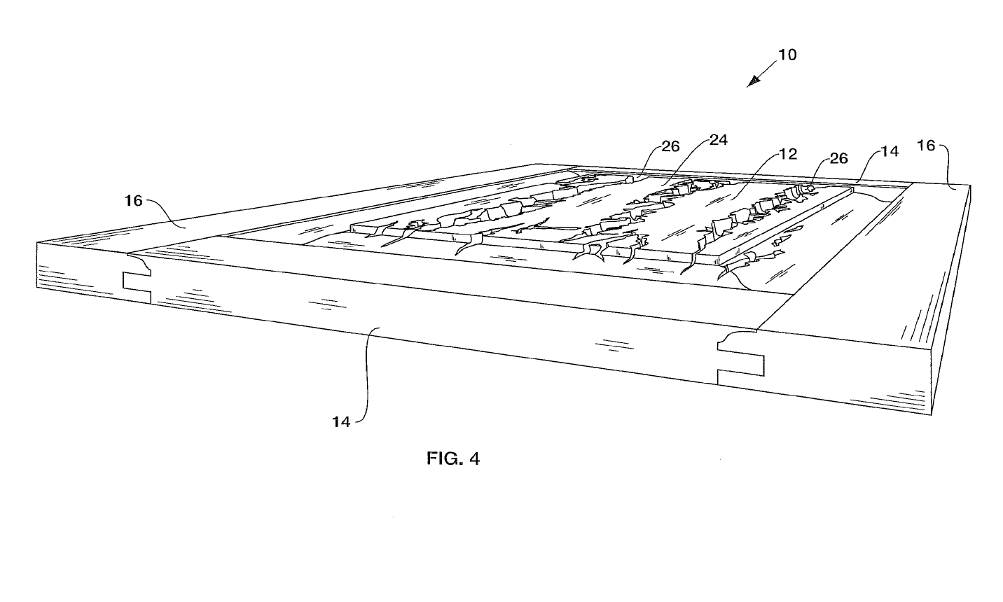

FIGS. 1-4 show a raised panel 10 in accordance with an embodiment. As seen in FIG. 1, a panel composite 12 exhibits a modified bark appearance, surrounded by a perimeter frame of rails 14 and stiles 16. The rails and stiles can be like those used in raised panel items used in furniture and building construction. As best seen in the sectional view of FIG. 2, the panel composite is a laminate of poplar bark 32 and a backing 22. The backing may be any suitable material, such as medium density fiberboard (MDF) or plywood. The backing may have a thickness of ⅛ to ¼ inch. In other embodiments, the panel composite includes two poplar bark slabs, each laminated to one side of the backing.

The panel composite 12 has been planed to a thickness of about ⅞th inch. The planing results in a medial portion having lands 24 and crevasses 26. Preferably, the lands 24 exhibit a wood grain. The crevasses 26 preferably run substantially continuously from one side to the other of the poplar bark slab, but the precise configuration of lands and crevasses will be the result of the machining of the irregular bark surface. The panel composite 12 has a perimeter 34 that has been machined and slopes to a thickness of 7/16th inch. In other embodiments, the panel composite 12 has a thickness of ⅝th inch. In other embodiments, the perimeter 34 has a thickness of ¼ inch. Other thicknesses may also be used within the scope of the invention.

After preparation of the panel composite, it is installed in the rails and stiles in conventional fashion, as discussed below.

The raised panel provides a very attractive and novel appearance, no two of which are alike, since each slab of bark will have its own unique appearance and resulting panel composite appearance.

Steps to Making a Poplar Bark Raised Panel:

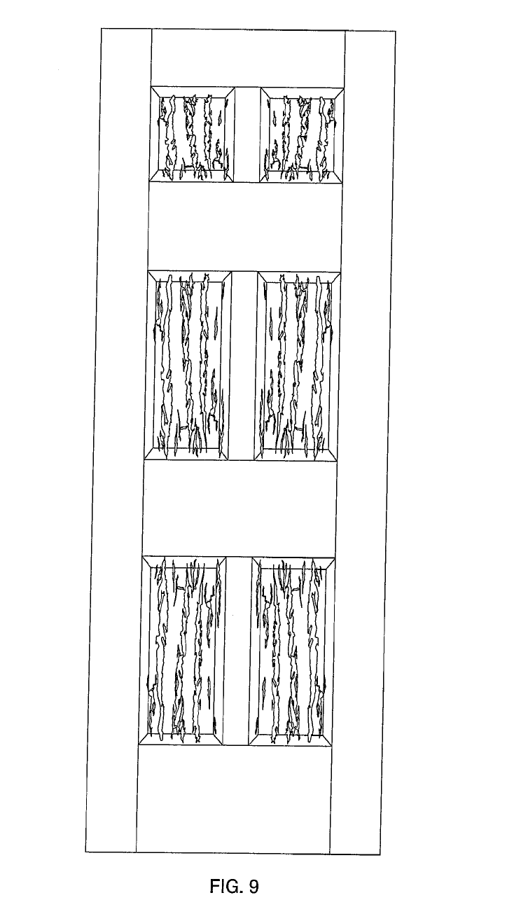

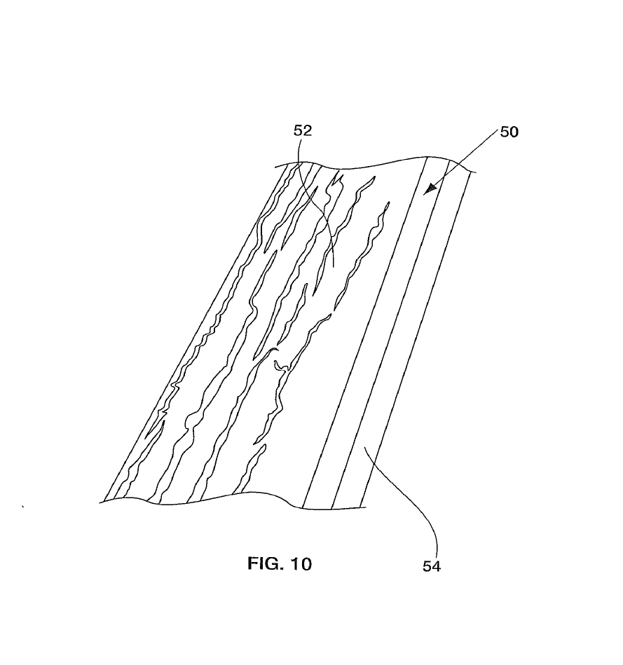

1. Laminate Bark to a stabilizing backing that can be ⅛″-¼″ MDF or Plywood. To apply the bark to both sides of a double-sided panel, laminate the bark to both sides of the stabilizing backing. Such an application would be useful for the door seen in FIG. 9. Conventional wood surface laminating processes, such as veneering, may be used.

2. Plane the resulting panel of bark and backing to a thickness of 9/16″-⅞″, depending on the application to which the raised panel will be put. The planing takes place on the bark side.

3. Cut the panel of bark and backing to the desired size.

4. Using a raised panel routing/shaper bit, shape the edges of the perimeter of the laminated panel. This results in tapering the edges down to ¼″- 7/16″ depending on application of panel.

5. Sand the bark side of the panel progressively with sand paper grits 150-220. The backing can be sanded, too.

6. Remove debris, such as by blowing out and vacuuming the crevasses in the panel composite to remove the dust from the surface.

7. Spray two coats of a vinyl sealer on the panel, sanding between coats.

8. Spray two coats of a pre-catalyzed lacquer, sanding after first coat. Top coat may differ according to a desired look. The preferred finish for many applications of trim or other non-flat panels would be a sprayed lacquer.

9. Mount the panel into surrounding stiles and rails in conventional fashion to yield a raised panel.

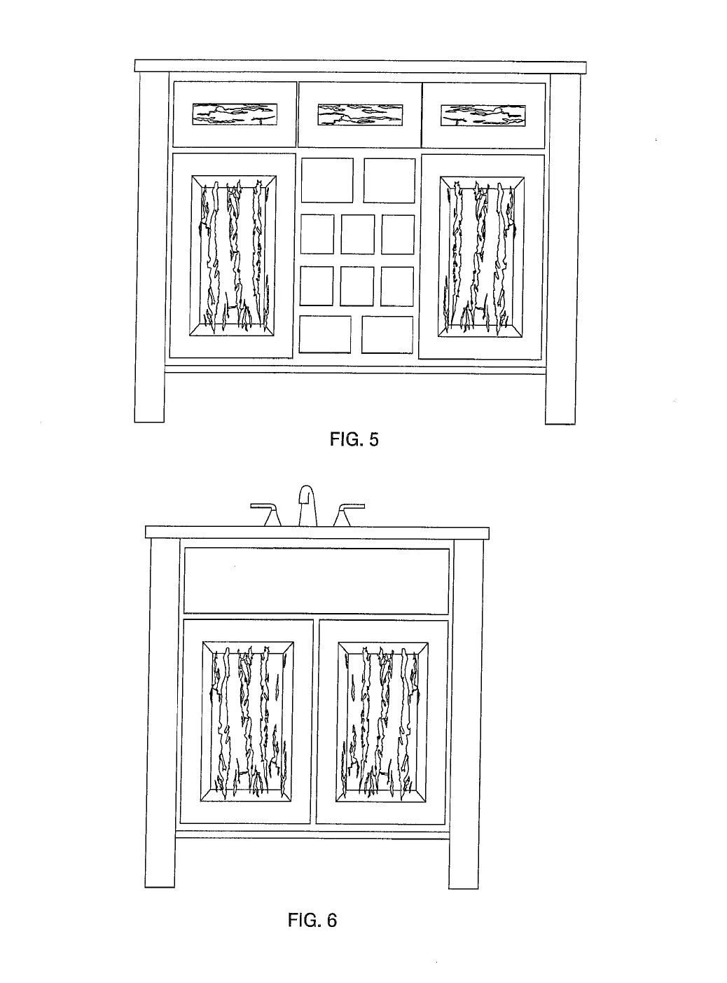

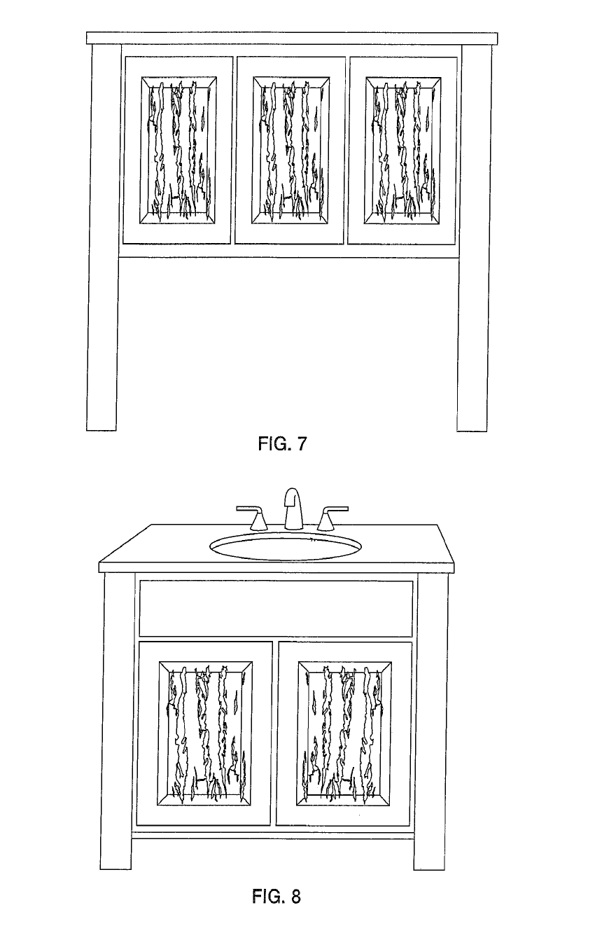

FIGS. 5-8 show examples of raised panels as installed on various items of furniture. FIG. 5 shows raised panels on a portable cabinet base. FIG. 6 shows raised panels on a sink base. FIG. 7 shows raised panels on a bed headboard. FIG. 8 shows raised panels on another sink base. FIG. 9 shows raised panel on a door for a house. Each of these raised panels was made in accordance with an aspect.

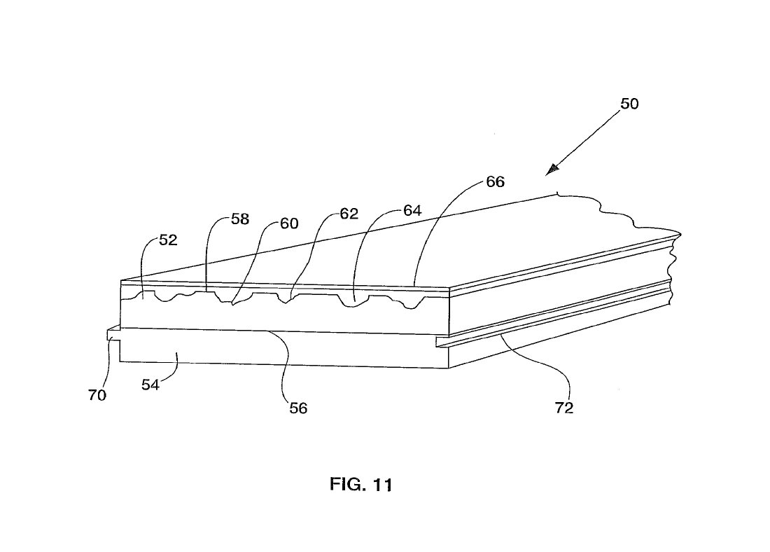

FIGS. 10-11 show perspective views of a flooring board 50 made using panels in accordance with an embodiment. As can be seen in FIG. 10, the poplar bark 52 is backed by a plywood or other stabilizing board 54 such as MDF, held in place by an adhesive 56 such as PUR HM or alternate adhesives. Preferably, the plywood is ⅜″ thick and the bark is ⅜″ for a ¾″ inch nail down floor. For a floating floor, the plywood or MDF will most likely be between ⅛″ and ¼″ thick. Other thicknesses may also be used within the scope of the invention. The PUR HM adhesive may be obtained from KLEIBERIT Adhesives USA, Inc. 109-B Howie Mine Road, Waxhaw, N.C. 28173 United States.

Other backing materials can also be used, such as other wood products including hardwoods, plastic composites, foamboard, honeycomb materials and cardboard and combinations thereof.

Preferably, the back side of the bark, away from the lands and crevasses, is sanded to achieve flatness prior to adhering to the stabilizing board. In some cases, that side of the bark will have recesses that cannot be flattened by sanding, and they can be filled with a conventional filling agent, such as epoxy or Bondo brand putty available from 3M Company, Minneapolis, Minn. The Bondo brand of filler or putty is composed of a polyester resin that, when mixed with a hardener (an organic peroxide) or catalyst, turns into a putty which then sets and hardens.

As in earlier mentioned embodiments, the poplar bark surface has lands 58 and crevasses 60, with the lands preferably planed flat. The planing can reduce the heights of the lands to varying degrees. The outer surface of the bark can be only lightly flattened, leaving the original gray bark color. Alternatively, the planing may expose the wood underlying the gray lay, and even grain in the wood. The crevasses, on the other hand, may remain in their harvested state, to the extent that lichens and the like remain on the bark, and will be visible in the final product. Each piece of bark, therefore will impart an individual look.

The crevasses may be treated with an optional Hot Coating 62 (such as Kleiberit 717) that provides a shell to harden the bark. It also serves as a bridge to bond the subsequently-applied filler 64 to the bark. The hot coating is followed by a filler 64 that fills in the crevasses and, generally, at least slightly covers the lands 58. In most cases, the coating 62 is omitted and the filler is applied directly to the bark surface. The filler can be any suitable material, such as acrylic or epoxy. Then, a Top Coat UV cured Lacquer 66 (such as Kleiberit 817) is applied. The materials are applied by a roller on a machine or other suitable mechanism. Top coat will differ according to client's desired look. The preferred top coat for many flooring applications will be a UV-cured hot melt lacquer.

In another embodiment, the initial hot coating is not used, and the resin is directly applied to fill the crevasses. Various resins can be used, particularly those known in the pre-finished flooring materials art, such as acrylics, epoxies, polyesters, polyurethanes and blends thereof. A blend of acrylic and polyester may be most suitable, with the acrylic providing hardness and the polyester affording flexibility. The resin may be colored with pigments, if desired. The resin may be selected to be suitable for UV curing, air curing, or combinations thereof. Conventional rapid curing of 100% UV cured resins should be avoided, however, because the rapid curing of the volume of resin in the crevasses that takes place when exposed to UV radiation causes dimensional changes in the body of the resin that cannot be compensated by the bark, imposing undesirable stresses on the bark. However, UV resins that do not have that characteristic may be used. Also, it may be preferable to impart vibration to the composite with uncured resin before curing, to coax any bubbles in the resin to float to the top and escape and not get trapped in the resin. Other methods of removing bubbles may also be used.

Because the uncured resin is quite liquid, the bark composite is preferably surrounded in some fashion when the resin is applied, to prevent the resin from draining out of the crevasses at the edges of the bark. This can be accomplished with a suitable jig or assembly line fencing on the sides of the bark composite workpieces. Alternatively, individual workpieces can have bands applied to their edges during resin application and curing.

After the filling and finishing process, the plywood and bark composite is machined in conventional fashion to form a tongue 70 on one side and a groove 72 on the other side of each flooring board. Desirably, the ends of the boards are also machined to form complementary tongues and grooves (not shown). A conventional waterproofing (such as Kleiberit 555.6) is applied to the tongue and groove to stabilize the moisture content of the finished piece. Although Kleiberit products have been mentioned, comparable products from other producers can be used.

A plurality of the flooring boards can be laid on a floor in the fashion of laying an oak flooring.

The panel can also be made into other components besides flooring. The filled composite can be machined to make a molding, such as chair rail, door or window frame or crown molding. It can also be configured to be used as furniture components, wall panels or ceiling tiles. (For ceiling tiles less dense ones of the backing materials mentioned above, such as foamboard and cardboard, may be preferred.) Individual panels can be glued at their edges to make larger panels, if desired, using gluing techniques that are conventional in the furniture making arts.

This process will only work with the poplar species. All other known bark species do not have the integrity to go through the shaping process. When the bark of other species is put through the process, it chips, tears out, or disintegrates. A preferred poplar is the tulip poplar.

Certain modifications and improvements will occur to those skilled in the art upon reading the foregoing description. It should be understood that all such modifications and improvements have been omitted for the sake of conciseness and readability, but are properly within the scope of the following claims.

What is claimed is:

1. A flooring panel comprising
a poplar bark slab having a top face, bottom face and two opposed side, the bottom face being laminated to a backing to make a flooring composite, the top face having lands and crevasses,
a filler on the top face of the slab filling the crevasses, and
a coating covering the filler and presenting a smooth, flat outer surface.

2. A flooring panel as claimed in claim 1 wherein the filler is a resin filler.

3. A flooring panel as claimed in claim 1 wherein the filler is blend of acrylic and polyester.

4. A flooring panel as claimed in claim 1 wherein the filler contains pigment to impart color to the filler.

5. A flooring panel as claimed in claim 1 wherein the backing is selected from the group consisting of medium density fiberboard (MDF), plywood, hardwoods, plastic composites, foamboard, honeycomb materials and cardboard and combinations thereof.

6. A flooring panel as claimed in claim 1 wherein the coating is a UV-cured hot melt lacquer.

7. A flooring panel as claimed in claim 1 wherein one of the opposed sides has a tongue protruding from it and the other side has a groove shaped, sized and located to receive and retain a tongue protruding from an adjacent flooring panel.

8. A panel for use in an architectural installation comprising
a poplar bark slab having a top face, bottom face and two opposed side, the bottom face being laminated to a backing to make a composite, the top face having lands and crevasses,
a filler on the top face of the slab filling the crevasses, and
the resulting composite panel with filler and coating being machined to obtain a shape selected from the group consisting of flooring, wall panel, ceiling panel, chair rail, door or window frame or crown molding.

9. A panel as claimed in claim 8 wherein the machined composite panel has a coating covering the filler and presenting a smooth outer surface.

10. A method of making an architectural panel comprising
providing a poplar bark slab that has a back side and top side that features lands and crevasses.
flattening the back side of the poplar bark slab,
adhering the back side of the poplar bark slab to a stabilizing backing to make a composite panel,
planing the top side of the bark of the composite panel of bark and backing,
removing debris from the crevasses in the composite panel,
surrounding edges of the composite panel to close off ends of the crevasses,
applying resin to the top side to fill the crevasses,
curing the resin,
machining the composite panel to obtain a shape selected from the group consisting of flooring, wall panel, ceiling panel, chair rail, door or window frame or crown molding.

11. A raised panel comprising
a poplar bark slab laminated to a backing to make a panel composite, the panel composite having a first thickness, including a medial portion having lands and crevasses and a perimeter machined to a second thickness less than the first thickness, and
rails and stiles surrounding the panel composite forming a frame around the panel composite, with the rails and stiles having grooves with the perimeter of the panel composite engaged in the grooves.

12. A raised panel as claimed in claim 11 wherein the panel composite has a maximum thickness of ⅝^{th} inch.

13. A raised panel as claimed in claim 11 wherein the perimeter has a thickness of ¼ inch.

14. A raised panel as claimed in claim 11 wherein the crevasses run substantially continuously from one side to the other of the poplar bark slab.

15. A raised panel as claimed in claim 11 wherein the lands exhibit a wood grain.

16. A raised panel as claimed in claim 11 wherein the panel composite is coated with a pre-catalyzed lacquer.

17. A raised panel as claimed in claim 11 wherein the backing is selected from the group consisting of medium density fiberboard (MDF) and plywood.

18. A raised panel as claimed in claim 11 wherein the backing has a thickness of ⅛ to ¼ inch.

19. A raised panel as claimed in claim 11 wherein the panel composite includes two poplar bark slabs, each laminated to one side of the backing.

20. A raised panel comprising
a poplar bark slab laminated to a backing selected from the group consisting of medium density fiberboard (MDF) and plywood to make a panel composite, the panel composite having a first thickness, including a medial portion having lands and crevasses and a perimeter machined to a second thickness less than the first thickness, the lands exhibiting a wood grain and the crevasses running substantially continuously from one side to the other of the poplar bark slab, a pre-catalyzed lacquer coating the panel composite, and
rails and stiles surrounding the panel composite fanning a frame around the panel composite, with the rails and stiles having grooves with the perimeter of the panel composite engaged in the grooves.

21. A method of making a raised panel comprising
laminating a poplar bark slab to a stabilizing backing to make a panel composite,
planing the panel composite of bark and backing
cutting the composite panel to a desired size,
shaping the edges of the perimeter of the composite panel with a raised panel routing/shaper bit, to obtain composite panel edges that taper,
sanding the bark side of the panel composite,
removing debris from the crevasses in the composite panel,
sealing the panel composite with a vinyl sealer,
spraying pre-catalyzed lacquer on the composite panel, and
mounting the composite panel into surrounding stiles and rails in conventional fashion to yield a raised panel.

22. A method as claimed in claim 21 wherein sealing includes applying two coats of vinyl sealer.

23. A method as claimed in claim 21 wherein spraying pre-catalyzed lacquer includes spraying two coats of lacquer.

24. A method as claimed in claim 21 wherein laminating includes laminating the bark to a backing selected from the group consisting of medium density fiberboard (MDF) and plywood.

25. A method as claimed in claim 21 wherein laminating includes laminating two slabs of bark, one to each sides of the backing to yield a double-sided panel.

26. A method as claimed in claim 21 wherein planing reduces the thickness of the panel composite to a thickness of 9/16-⅞ inch.

27. A method as claimed in claim 21 wherein shaping tapers the edges down to ¼- 7/16 inch.

28. A method as claimed in claim 21 wherein sanding includes sanding progressively with sand paper grits of 150-220.
